(19) United States
(12) Patent Application Publication
(10) Pub. No.: US 2026/0259576 A1
(43) Pub. Date: Sep. 3, 2026

(54) Regulator Circuit With Multiple Levels

(71) Applicant: Eric BHARUCHA, St-Augustin-de-Desmaures (CA)

(72) Inventors: Eric BHARUCHA, St-Augustin-de-Desmaures (QC) (CA); Benoit GOSSELIN, Lac-Beauport (QC) (CA)

(73) Assignee: Eric BHARUCHA, St-Augustin-de-Desmaures (CA)

(21) Appl. No.: 18/879,590

(22) PCT Filed: Jun. 30, 2023
(86) PCT No.: PCT/CA2023/050897

§ 371 Date: Dec. 27, 2024

Related U.S. Application Data
(60) Provisional application No. 63/367,406, filed on Jun. 30, 2022.

(51) Int. Cl. G05F 1/563; H02J 1/14

(52) U.S. Cl. CPC G05F 1/563; H02J 1/14

(57) ABSTRACT

A regulator circuit for regulating an input voltage is provided. The regulator circuit comprises a plurality of voltage regulators connected in series to the input voltage; and a current spillway operable to allow current to selectively bypass at least one of the plurality of voltage regulators. A method for regulating power supplied to a plurality of loads is also provided. The method comprises supplying power to the plurality of loads via a plurality of stages of voltage regulators connected in series to a power source; determining one of the plurality of stages drawing a highest load current to power its load; calculating a difference between the highest load current and the current drawn by each stage to power its load; and causing a current to bypass the voltage regulator in each stage, the bypass current corresponding to the calculated difference.

### CROSS-REFERENCE TO RELATED APPLICATIONS

This application claims the benefit of and priority to U.S. provisional patent application No. 63/367,406 entitled REGULATOR CIRCUIT WITH MULTIPLE LEVELS and filed on Jun. 30, 2022, the content of which is hereby incorporated by reference in its entirety.

### TECHNICAL FIELD

The present disclosure generally relates to power supply circuits, and more specifically to a multi-stage regulator topology for efficiently splitting a raw power supply source into smaller voltage domains.

### BACKGROUND

Power management is an important consideration with electronic devices, and particularly implantable medical devices. Such devices typically require power sources that supply voltages in different low-voltage domains. While systems for generating multiple voltage are known in the art, such systems can waste power and are inefficient for low-voltage applications and/or for devices that often operate in an idle or low-power mode. There is therefore a need for an alternate solution.

### SUMMARY

According to an aspect, a regulator circuit for regulating an input voltage is provided. The regulator circuit comprises a plurality of voltage regulators connected in series to the input voltage; and a current spillway operable to allow current to selectively bypass at least one of the plurality of voltage regulators.

In an embodiment, the current spillway is configured to allow current to selectively bypass each of the plurality of voltage regulators.

In an embodiment, each of the plurality of voltage regulators comprises an input terminal, an output terminal and a negative terminal; and each of the plurality of voltage regulators is configured to draw a load current to generate a specific output voltage across a load between its output terminal and negative terminal.

In an embodiment, the plurality of voltage regulators is configured to generate specific output voltages in at least two different voltage domains.

In an embodiment, at least one of the plurality of voltage regulators is configured to generate an output voltage below 1V.

In an embodiment, the plurality of voltage regulators comprises a first voltage regulator, at least one subsequent voltage regulator, and a final voltage regulator; wherein the first voltage regulator has its input terminal connected to the input voltage, each of the at least one subsequent voltage regulator has its input terminal connected to the negative terminal of a previous voltage regulator; and the final voltage regulator has its negative terminal connected to a ground.

In an embodiment, the current spillway of each of the plurality of voltage regulators is configured to allow an adjustable current to pass between the input terminal and the negative terminal of the voltage regulator.

In an embodiment, the current spillway of each of the plurality of voltage regulators comprises a MOSFET having a first terminal connected to the input terminal of the voltage regulator, and a second terminal connected to the negative terminal of the voltage regulator, a control voltage applied to a gate terminal of the MOSFET allowing to adjust the current passing between the input terminal and the negative terminal of the voltage regulator.

In an embodiment, the MOSFET is a low dropout MOSFET.

In an embodiment, the regulator circuit comprises a plurality of stages, each stage comprising one of the plurality of voltage regulators and a corresponding current spillway; the regulator circuit further comprising a controller operatively connected to each of the plurality of stages, the controller being operable to selectively adjust the current passing through the current spillway in each of the stages, thereby adjusting a total current in each stage comprising the current passing through the current spillway and the load current drawn by the voltage regulator and the load.

In an embodiment, the controller is configured to adjust the current passing through each of the current spillways such that the total current passing through each stage is equal.

In an embodiment, the controller is configured to adjust the total current passing through each stage by detecting the current passing through each of the plurality of stages; identifying a master stage corresponding to one of the plurality of stages drawing a highest total current, the other ones of the plurality of stages being identified as slave stages, and automatically adjusting the total current passing through the slave stages to match the current passing through the master stage.

In an embodiment, the controller comprises a comparator circuit to compare the current drawn by each of the plurality of stages and identify the master stage, and a difference amplifier to subtract the current passing through each of the slave stages from the current passing through the master stage to compute a desired current through the spillway of each slave stage.

In an embodiment, the load across each of the voltage regulators is a dynamic load, further wherein the controller is configured to continuously adjust the current passing through each of the plurality of stages to balance the regulator circuit as the current drawn by the dynamic load changes.

In an embodiment, the regulator circuit is configured to control charging of a battery pack having a plurality of battery cells, the load across each of the voltage regulators comprising one of the battery cells.

In an embodiment, the regulator circuit is configured to control charging of a battery assembly having a plurality of battery cells, wherein said plurality of batteries cells are divided into a plurality of battery groups, each battery group comprising a subset of said plurality of batteries cells, the load across each of the voltage regulators comprising one of the battery groups.

In an embodiment, at least one of the plurality of battery cells is a dead cell, further wherein the controller is configured to detect and bypass the dead cell during charging or discharging using the current spillway.

In an embodiment, the controller comprises an analog circuit.

In an embodiment, the controller comprises a digital circuit.

In an embodiment, each of the plurality of voltage regulators comprises an internal control loop to regulate voltage and an external control loop for controlling the current bypassing the voltage regulator via the current spillway, further wherein the internal and external control loops are modulated to control noise.

In an embodiment, the input voltage is provided from a DC source, the regulator circuit comprising a commutation stage coupled to each of the plurality of voltage regulators configured to generate an AC output.

In an embodiment, the voltage regulators are linear regulators.

In an embodiment, the linear regulators are low-dropout regulators.

In an embodiment, the voltage regulators are switching induction-based regulators.

In an embodiment, the voltage regulators are capacitive-based charged pumps.

According to another aspect, a method for regulating power supplied to a plurality of loads is provided. The method comprises supplying power to the plurality of loads via a plurality of stages of voltage regulators connected in series to a power source; determining one of the plurality of stages drawing a highest load current to power its load, the determined one of the plurality of stages being identified as a master stage and the remaining ones of the plurality of stages being identified as slaved stages; for each of the plurality of stages, calculating a difference between the highest load current and the current drawn by the stage to power its load; and causing a current to bypass the voltage regulator in the stage, the bypass current corresponding to the calculated difference. A total current drawn by each of the stages is equal, the total current of each stage corresponding to a sum of the current drawn by the stage to power its load and the current bypassing the voltage regulator in the stage.

In an embodiment, each of the plurality of stages comprises one of the voltage regulators and a corresponding current spillway.

In an embodiment, each current spillway is operable by a controller operatively connected to a gate of the corresponding current spillway, to selectively adjust the current passing through the current spillway in each of the stages, thereby adjusting a total current in each stage comprising the current passing through the current spillway and the load current drawn by the voltage regulator and the load.

In an embodiment, the controller is configured to adjust the current passing through each of the current spillways such that the total current passing through each stage is equal.

In an embodiment, the controller comprises a comparator circuit to compare the current drawn by each of the plurality of stages and identify the master stage, and a difference amplifier to subtract the current passing through each of the slave stages from the current passing through the master stage to compute a desired current through the spillway of each slave stage.

In an embodiment, each of the plurality of loads is a dynamic load, further wherein the controller is configured to continuously adjust the current passing through each of the plurality of stages to balance the voltage regulators as the current drawn by the dynamic load changes.

In an embodiment, the controller comprises an analog circuit.

In an embodiment, the controller comprises a digital circuit.

In an embodiment, each of the plurality of voltage regulators comprises an internal control loop to regulate voltage and an external control loop for controlling the current bypassing the voltage regulator via the current spillway, further wherein the internal and external control loops are modulated to control noise.

### BRIEF DESCRIPTION OF THE DRAWINGS

FIG. 1 is a circuit diagram showing a regulator circuit with multiple stages, in accordance with a first embodiment.

FIG. 2 is a circuit diagram showing a regulator circuit with two stages, in accordance with a second embodiment. FIG. 2A is a detail view of a regulator in the regulator circuit of FIG. 2.

FIG. 3A is a circuit diagram showing one of a plurality of stages of a regulator circuit, in accordance with an embodiment.

FIG. 3B is a circuit diagram showing a first sub-circuit of a controller used to control current through each regulator in the circuit of FIG. 3A.

FIG. 3C is a circuit diagram showing a second sub-circuit of the controller used to determine the highest current stage among regulator stage as in the circuit of FIG. 3A.

FIG. 3D is a circuit diagram showing a third sub-circuit for converting a control signal into a gate voltage suitable for controlling the spillways in the circuit of FIG. 3A.

FIG. 4 is a schematic diagram showing a cascade control model of a regulator circuit, in accordance with an embodiment.

FIG. 5 is a flow chart illustrating a method for controlling spillways in a regulator circuit, in accordance with an embodiment.

FIG. 6 is a circuit diagram showing a regulator circuit in accordance with an embodiment in which the circuit is used to balance cell in an electric vehicle battery.

FIG. 7 is a circuit diagram showing a regulator circuit in accordance with an embodiment in which the circuit includes a commutation stage for generating an AC output from a DC input; in which multiple loads are powered by different phases generated from the same set of waterfall regulators.

FIG. 8 is a graph showing a sinusoid-like output of the regulator circuit of FIG. 7, resulting from commutators operated in sequence.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art, that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

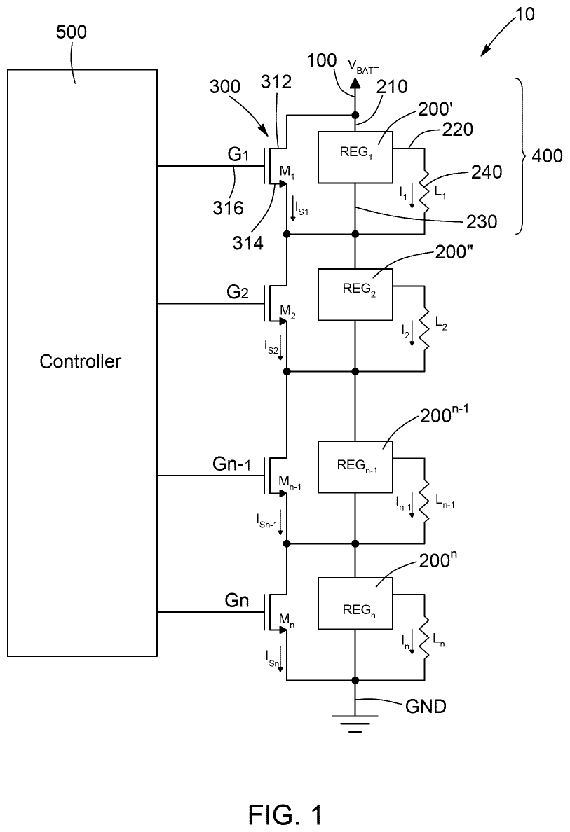

With reference to FIG. 1, an exemplary regulator circuit 10 for regulating an input voltage 100 is shown according to an embodiment. The regulator circuit 10 includes a plurality of voltage regulators 200 for dividing the input voltage 100 (VBATT in the embodiment shown), a plurality of current spillway 300 operable to allow current to selectively bypass each of the plurality of voltage regulators 200, and a controller 500 configured to adjust the current passing through each of the current spillways 300. The input voltage 100 can, for example, be provided by a power supply source.

In the present embodiment, the voltage regulators 200 are linear voltage regulators, each comprising an input terminal 210, an output terminal 220 and a negative terminal 230. The voltage regulators 200 are connected in series such that after a first regulator, the input terminal 210 of each subsequent regulator is connected to the negative terminal 230 of a previous regulator. More specifically, in the present embodiment, the circuit 10 comprises a first regulator 200′ having its input terminal 210 connected to a voltage source providing input voltage 100, a plurality of subsequent regulators 200″ to 200ⁿ each having their input terminal 210 connected to the negative terminal 230 of a previous regulator 200′ to 200ⁿ⁻¹, and a final regulator 200ⁿ having its negative terminal 230 connected to ground (GND). Although at least four series-connected regulators 200 are shown in the present embodiment, it is appreciated that other configurations are possible. For example, in some embodiments the regulator circuit 10 can comprise as few as two regulators 200, including a first regulator 200′ and a subsequent regulator 200ⁿ that is also the final regulator.

Each voltage regulator 200 is configured to draw a load current to supply a specific output voltage to a load 240 connected to its output terminal 220. In the present embodiment, each voltage regulator 200 has a load 240 connected between its output terminal 220 and its negative terminal 230. Accordingly, the loads 240 do not share a common ground, and the voltage regulators can supply different voltages to the loads 240 in different voltage domains. For example, if the input voltage 100 is 3.7V and the regulator circuit comprises two voltage regulators 200, a first output voltage domain can be from 0V (Ground) to 1.8V, which is a potential difference of 1.8V (1.8V-0V), and a second output voltage domain can be from 1.9V to 3.7V, which is a potential difference of 1.8V (3.7V-1.8V). In another example, the input voltage 100 can be 1.35V and the regulator circuit comprises two voltage regulators 200. A first output voltage domain can be from 0V (Ground) to 0.9V, which is a potential difference of 0.9V (0.9V-0V), and a second output voltage domain can be from 1V to 1.35V, which is a potential difference of 0.35V (1.35V-1.0V). In such examples, the precision of each domain voltage can be as little as +0.05-0.0V. As will be appreciated, a plurality of output voltage domain can be supplied, with output voltage domain as low as below 1V.

Although in the present embodiment the loads 240 do not share a common ground, it is appreciated that other configurations are possible. For example, in some embodiments at least some of the loads 240 can share a common ground.

As can be appreciated, the loads 240 can be dynamic loads, such that varying load currents may be required to maintain the specific output voltages supplied to the loads 240 via the regulators. Accordingly, each of the regulators 200 can be connected to a current spillway 300 that allows for current to selectively bypass the regulator 200 and be passed on to subsequent regulators 200 as needed. The current spillways 300 are connected between the input terminal 210 and negative terminal 230 of each regulator 200 and are operable such that the amount of current bypassing each regulator 200 can be dynamically adjusted. In the present embodiment, the current spillways 300 are implemented via field-effect transistors (FETs), and more specifically metal-oxide-semiconductor field-effect transistors (MOSFETs), each having a first terminal 312, a second terminal 314 and a gate terminal 316. The first terminal 312 of each MOSFET is connected to the input terminal 210 of its corresponding voltage regulator 200, and its second terminal 314 is connected to the negative terminal 230 of its corresponding voltage regulator 200. A control voltage supplied to the gate G terminal 316 of each current spillway 300 allows adjusting the amount of current passing between the input terminal 210 and the negative terminal 230 of the voltage regulator 200. In the present embodiment, the current spillway 300 comprises low-dropout N-type MOSFETS (NMOS), such that the first terminal 312 corresponds to a drain terminal and the second terminal 314 correspond to a source terminal, although it is appreciated that other types of transistors can be used, such as P-type MOSFETS (PMOS), with the first terminal 312 corresponding to a source terminal and the second terminal 314 corresponding to a drain terminal, or a complementary pair of NMOS and PMOS transistors (CMOS).

In the illustrated embodiment, the regulator circuit 10 comprises a plurality of stages 400, with each stage 400 comprising one of the plurality of voltage regulators 200, a load 240 and a corresponding current spillway 300. Each stage 400 has a total current flowing therethrough, corresponding to a sum of the load current I drawn by the voltage regulator 200 to power its load 240 and the current Is passing through the current spillway 300. The total current passing through each stage is passed on to the following stage such that when the circuit 10 is balanced, the total current through each stage 400 is equal. As can be appreciated, the output of a stage 400 can be kept stable by adjusting the current passing through its spillway 300 to maintain a desired total current as the current drawn by the voltage regulator 200 changes. The spillway 300 of each stage 400 can be operated individually, such that for each stage 400 the ratio of current circulating in the current spillway 300 versus the current circulating in the voltage regulator 200 can be adjusted as needed. In some embodiments, the stages 400 can be operated to dynamically adjust the current spillways 300 to ensure that the total current through one stage is equal to the maximum total current of any of the other stages. For example, a stage having the highest current circulating therethrough can be identified (i.e. the stage having a load drawing the most current), and the remaining stages 400 can be adjusted to have a total current that is equal to the identified stage.

The controller 500 is provided to dynamically control the current flowing through the spillway 300 in each stage 400 to keep the circuit 10 balanced. The controller 500 is operatively connected to each of the plurality of stages and provides control signals to individually operate the spillway 300 in each of said stages. In the present embodiment, the controller 500 provides control signals in the form of a gate voltage G supplied to the gate terminal 316 of the MOSFET in each current spillway. It is appreciated, however, that different configurations are possible. As will be described in more detail hereinafter, the controller 500 can also be configured to operate responsive to feedback signals. For example, the controller 500 can receive feedback signals allowing to monitor the current circulating in each stage and provide a control voltage to each of the current spillways and to allocate the appropriate current in each stage and ensure a balanced circuit 10. As can be appreciated, the controller 500 can be implemented using digital and/or analog components as needed.

In the illustrated example, the regulator circuit 10 comprises n stages 400:
a first stage comprising a first voltage regulator (REG₁), a first load (L₁), and a first current spillway (M₁);
at least one subsequent stage comprising at least one subsequent voltage regulator (REG₂ to REGₙ₋₁), at least one subsequent load (L₂ to Lₙ₋₁), and at least one subsequent current spillway (M₂ to Mₙ₋₁); and
a final stage comprising a final voltage regulator (REGₙ), a final load (Lₙ) and a final current spillway (Mₙ).

The first voltage regulator (REG₁) has its input terminal 210 connected to the input voltage 100, each of the at least one subsequent voltage regulator (REG₂ to REGₙ₋₁) has its input terminal 210 connected to the negative terminal 230 of the voltage regulator in a previous stage; and the final voltage regulator (REGₙ) has its negative terminal 230 connected to a ground (GND). In the illustrated embodiment the voltage regulators are linear regulators, but it is appreciated that other configurations are possible. For example, in some embodiments the voltage regulators can be replaced by switching inductance-based regulators or capacitive based charge pumps.

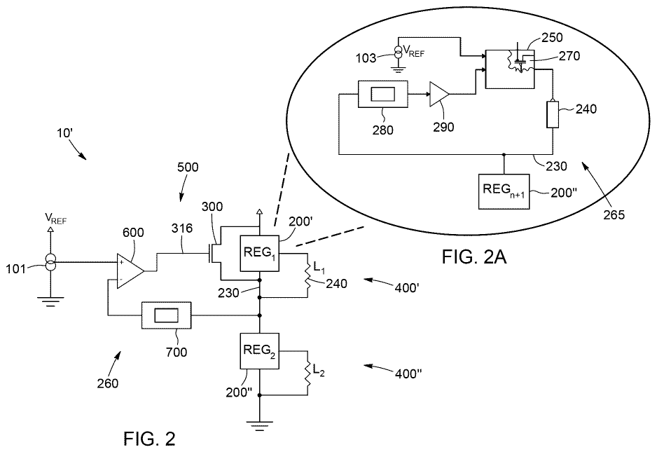

With reference to FIG. 2, an exemplary regulator circuit 10′ is shown according to an embodiment which utilizes an analog controller 500 for controlling current through the spillway. In this embodiment, the regulator circuit 10′ includes two stages 400′, 400″ and comprises two voltage regulators 200′, 200″ and a current spillway 300. The stages 400′, 400″ comprise two control loops, namely a first control loop 260 that regulates the total current through each stage, and a second control loop 265 within each regulator 200′, 200″ that regulates the voltage supplied to their corresponding load 240.

In the present embodiment, the first stage 400′ is treated as a slave stage in that the first control loop 260 is configured to adjust current passing through the current spillway 300 responsive to current requirements of the second stage 400″, which is treated as the master. More specifically, the first control loop 260 comprises an operational amplifier 600 having its non-inverting input coupled to a reference voltage source 101, its inverting input coupled to the negative terminal 230 of the first regulator 200′, and its output coupled to the gate terminal 316 of the MOSFET in the current spillway 300. A feedback signal is thus received from the negative terminal 230 of the first regulator 200′, and the feedback signal is converted to a gate voltage for driving the MOSFET of the current spillway 300 via the operational amplifier 600. It is appreciated, however, that other configurations are possible.

The first control loop 260 can further comprise a filter 700 between the negative terminal 230 of the first regulator 200′ and the inverting input of the operational amplifier 600, for example a low pass filter to limit the frequency of the feedback signal and thus filter rapid variations that would render the system unstable, such as unwanted noise. The filter 700 can be used in specific applications such as biomedical applications where cancellation of unwanted electronic noise is desired, although it is appreciated that the filter 700 can be omitted in other applications.

In some embodiments, the first control loop 260 can be a proportional-integral-derivative (PID) control loop mechanism, a proportional-integral (PI) control loop mechanism, a proportional-derivative (PD) control loop mechanism, or any other control loop mechanism employing the feedback signal. In such embodiments, the proportional (P) part of PID, PI or PD is given by a gain of the operational amplifier 600 and the integral (I) or derivative (D) part of PID, PI or PD is given by the filter 700. Such control loop mechanisms can provide stable non-oscillatory response to changes in current demand. In some embodiments, a capacitor can be used on the output of the first regulator 200′ and the filter 700 in the first control loop 260 can comprise a Miller capacitor filter.

With reference now to FIG. 2A, a detail view of a voltage regulator 200 in the circuit 10′ is shown. In the present embodiment, the voltage regulator 200 comprises a linear regulator 250 comprising a pass MOSFET 270 that determines the dropout voltage of the voltage regulator 200. In the present embodiment, the MOSFET 270 is a low-dropout P-type MOSFET, but it is appreciated that other configurations are possible. The regulator 200 further includes the second control loop 265, comprising at least a filter 280 and a buffer 290 providing a feedback loop response. The filter 280 is connected between the negative terminal 230 of the voltage regulator 200 and an input of the buffer 290, and an output of the buffer 290 is connected to a negative terminal of the linear regulator 250. A reference voltage 103 is provided at a positive terminal of the linear regulator 250 to set the target output voltage of the linear regulator 250.

The filter 280 can be used to attenuate high frequencies that could create noise in the voltage regulator. The filter 280 can be a low pass frequency (LP) filter, a high-cut filter, a treble-cut filter, or any other type of suitable filter. The filter 280 is designed to allow only passage of signals with a frequency lower than a cutoff frequency and to attenuate signals with frequencies higher than the cutoff frequency. The filter 280 prevents potential current noise generated by the junction 230 between stages to be propagated in the second control loop 265. The buffer 290 can be a buffer amplifier, providing an electrical impedance transformation from one circuit to another, preventing the signal from the filter 280 from being affected by an unwanted voltage. In some embodiment, an active filter can be used in the second control loop 265, where the buffer 290 is an amplifier of the active filter, providing a gain to the feedback signal.

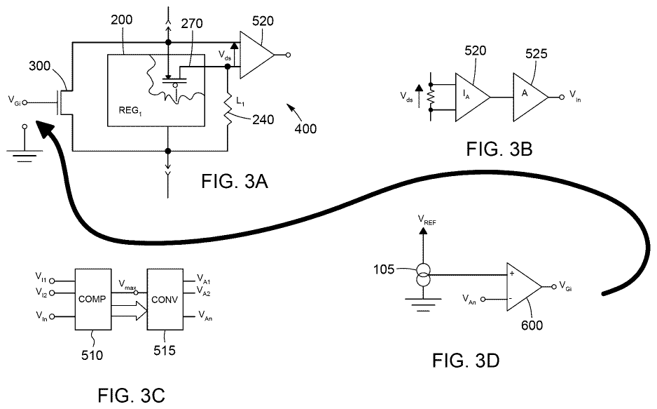

Referring now to FIGS. 3A-3D, components of an exemplary regulator circuit 10 are shown, the exemplary regulator circuit utilizing a digital controller 500 for controlling current through spillways 300. Broadly described, the controller 500 is configured to adjust spillways 300 in a plurality of stages 400 to follow one of the stages having the highest current. This is accomplished by monitoring the current of the pass MOSFET 270 in each stage 400 and identifying a master stage corresponding to the stage having the highest pass MOSFET 270 current, referred to hereinafter as the master current I_{MASTER}. The remaining stages are identified as slave stages, and the current of the pass MOSFETs 270 in the slave stages are referred to as slave currents I_{SLAVE}. Following identification of the master and slaves, the controller is configured to close the spillway of the master stage and adjust the spillway in each slave stage as needed. Specifically, for each stage, the slave current I_{SLAVE} is subtracted from the master current I_{MASTER} to calculate the amount of current to allow to pass via the spillway 300. A corresponding control signal can then be provided by the controller 500 to the spillway 300 to allow the calculated current to pass.

Where the spillway 300 is implemented via a MOSFET, the control signal can be provided in the form of a controlling voltage Va at the gate terminal 316 of the MOSFET 300. In such embodiments, the master stage can be modeled as a resistor, such that:

$${V}_{a}^{-} = ( \frac{{V}_{OUT \_ MASTER}}{{I}_{MASTER}} ) ( {I}_{MASTER} - {I}_{SLAVE} )$$

where V_{OUT_MASTER} corresponds to the output of the voltage regulator in the master stage. This can be simplified to:

$${V}_{a}^{-} = {V}_{OUT \_ MASTER} ( 1 - \frac{{I}_{SLAVE}}{{I}_{MASTER}} )$$

which shows that the control voltage for the spillway 300 is a function of the ratio of master current and slave current.

FIG. 3A shows one stage 400 of the exemplary circuit 10, comprising a voltage regulator 200 that can be part of a plurality of n stages in the circuit. As explained above, the voltage regulator 200 comprises a low-dropout pass MOSFET 270.

The controller 500 is coupled to each stage 400 and comprises:
a first sub-circuit for measuring the current passing through each of the plurality of stages 400 and generating a control signal therefrom (FIG. 3B);
a second sub-circuit for identifying the master stage and the slave stages, and generating control signals to control the spillways in each stage (FIG. 3C), and
a third sub-circuit to convert the control signals from the second-subcircuit into a gate voltage for applying to the gate terminals of the MOSFETs in the spillways (FIG. 3D).

FIG. 3B shows a part of the first sub-circuit for measuring the current passing through a given stage n of the plurality of stages and generating a corresponding control signal Vᵢₙ to control the spillway of the n^{th} stage 400. To determine the current I_{A} passing through the stage 400 (referred to herein after as the pass current), the drain-source voltage V_{ds} of the pass MOSFET 270 of the voltage regulator 200 is measured. In the present embodiment, the voltage V_{ds} is monitored by a subtractor, and more specifically a digital differential amplifier (DDA) 520 configured to calculate a difference or delta D between drain and source terminals of the MOSFET 270. The delta D is further scaled, for example via an amplifier 525 having a gain A, to generate a normalized control signal Vᵢₙ that can be compared against similar measurements in other stages. In the manner described above, the generated control signal Vᵢₙ is proportional to the current I_{A} passing through the MOSFET 270, such that:

$${I}_{A} ∝ 1 / {r}_{o} ∝ {g}_{m} ∝ Δ \cdot A = {V}_{{I}_{n}}$$

Where rₒ is the output resistance of the MOSFET 270 and gₘ is the transconductance of the MOSFET 270. Although the measurements described above are with respect to the P-type MOSFET 270, it is appreciated that similar measurements can be carried out to generate a control signal where an N-type MOSFET is used.

FIG. 3C shows the second sub-circuit of the controller 500. The controller 500 is coupled to the n stages of the regulator circuit 10. Therefore, the controller 500 receives the n control signals Vᵢₙ provided by each of the n stages and compares the control signals Vᵢₙ from each stage n to identify the master stage and generate control signals V_{An} to control the spillways 300 in each of the n stages. In the present embodiment, this functionality is carried out by the controller 500 using two sub-components, namely a comparator circuit 510 and a converter circuit 515.

The comparator circuit 510 receives each of the n values of control signals Vᵢₙ and is configured to identify a master stage therefrom. In the present configuration, the master stage corresponds to one of the n stages having a highest current I_{A} passing through its MOSFET 270. Accordingly, the comparator circuit 510 is configured to identify the stage having the highest pass current I_{A}. As mentioned above, the control signals Vᵢₙ are normalized and proportional to the pass current I_{A} in each stage. Thus, the comparator circuit 510 is configured to identify the master stage by comparing the n values of control signals Vᵢₙ and determine a maximum value Vₘₐₓ of all the n values of control signal Vᵢₙ. The maximum value Vₘₐₓ is subsequently output by the comparator circuit 510. It should be appreciated that in other embodiments, other strategies can be applied to identify the master stage.

The maximum value Vₘₐₓ output by the comparator circuit 510 is received by the converter circuit 515, which uses this value to determine the currents that should pass through the spillways 300 in each stage and generate corresponding spillway control signals V_{An}. As can be appreciated, the current that should pass through each spillway 300 corresponds to a difference between the pass current I_{A} of that stage Iₙ and the pass current I_{A} of the master stage I_{MASTER}. Since the control signals Vᵢₙ are normalized and proportional to the pass current I_{A} in each stage as mentioned above, the converter circuit 515 can determine the spillway current and generate the corresponding spillway control signals V_{An} for each of the n stages by simply subtracting the Vᵢₙ for each stage from Vₘₐₓ. As can be appreciated, this will result in a nil spillway control signal V_{An} for the master stage (the spillway 300 of the master stage will be closed), and a spillway control signal V_{An} for the remaining slave stages representing a magnitude of current that should be allowed to pass in the spillways 300 of those slave stages.

As mentioned above, the spillways 300 in the present embodiment are implemented via MOSFETs. Accordingly, the spillway control signal V_{An} may need be converted, in each of the n stages, into a gate voltage V_{Gi} suitable for controlling the spillway MOSFETs. In the present embodiment, and as shown in the third sub-circuit of FIG. 3D, this is accomplished using an operational amplifier 600 in each of the n stages. The operational amplifier 600 is configured to scale and/or offset the spillway control signal V_{An} based on the parameters of the spillway MOSFET such that a gate voltage V_{Gi} can be generated which causes the MOSFET to allow the desired current to pass through the spillway 300. In the present embodiment, the operational amplifier 600 has its non-inverting input coupled to a reference voltage 105, its inverting input coupled to the converter 515 and receiving V_{An}, and its output coupled to the gate terminal 316 of the spillway MOSFET 300. It is appreciated, however, that other configurations for adapting spillway control signal V_{An} to operate the spillway 300 are possible, for example depending on requirements of the components used to implement the spillway 300.

As can be appreciated, the controller 500 and its sub-components 510, 515, can be implemented using digital and/or analog components. The above-described processes for monitoring the circuit 10 and generating control signals can be repeated periodically or continuously, depending on the nature of the controller 500 (digital or analog) and to account for variations of the dynamic loads 240.

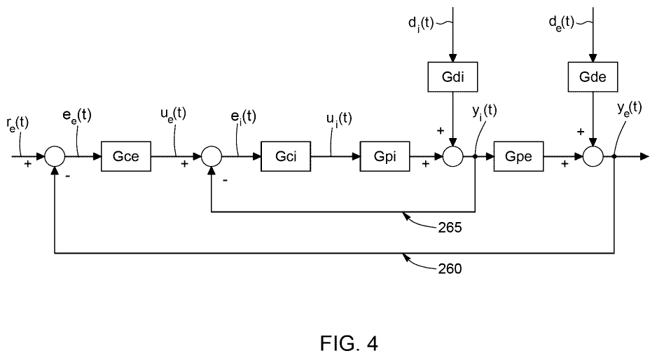

As mentioned above, the regulator circuit 10 includes two control loops, namely a first control loop 260 that regulates the total current through each stage, and a second control loop 265 within each regulator that regulates the voltage supplied to their corresponding loads 240. As shown in FIG. 4, this double feedback loop can be modeled as a cascade control system, including an external loop corresponding to the first loop 260 and an internal loop corresponding to the second loop 265. In both the external loop 260 and the internal loop 265, G_{c} and Gₚ (G_{ce} and Gₚₑ for the external loop 260 and G_{ci} and Gₚᵢ for the internal loop 265) represent a transfer function of the control loop mechanism, and Gd represents the noise or perturbation to be canceled (G_{de} represents the spillway noise of the external loop 260 and G_{di} represents the load perturbation and regulator noise of the internal loop 265). Gₚ is a plant transfer function, indicating the relation between an input signal and an output signal of a system without feedback, commonly determined by physical properties of the system. G_{c} is a control transfer function, indicating an output response as a function of an input signal in a determined response time, the transfer function being for example a Laplace transform. In such embodiment, the transfer function G_{c} applied to Gₚ and G_{d} can cancel the noise G_{d} from the current output signal. In other words, G_{ce} represents the external (master) controller, and G_{ci} represents the internal (slave) controller, Gₚₑ is the external controlled system, and Gₚᵢ is the internal controlled system. The signals rₑ and rᵢ (not shown) are the external and the internal reference values. It is noted that in the embodiment shown, the signal uₑ corresponding to the manipulated variable that results from the control input calculated by the external controller G_{ce} is equal to the internal reference value rᵢ (n=uₑ). yₑ and yᵢ are the external and the internal controlled outputs, eₑ and eᵢ are the external and the internal control errors, and uᵢ is the manipulated variable that results from the control input calculated by the internal controller G_{ci}. dᵢ and dₑ are the disturbance that influence the controllers. The cascade control system allows to correct disturbances arising within the internal loop by the internal controller before affecting the value of the external controlled output. The controlled output yₑ is fed back to the external controller, and a signal from an intermediate stage of the process yᵢ is fed back to the internal controller.

In some embodiment, and in order to ensure a stability of the regulator circuit, the internal loop 265 can be configured to be faster than the external loop 260, in order for the regulator to suppress fast transients. The feedback internal loop 265 can, for example, be accelerated by using a fast op-amp such as a cascode in lieu of the buffer 290 shown in FIG. 2A. In some embodiments, the external loop 260 can be slowed down by using some low pass filters 700 associated with a buffer as shown in FIG. 2. Such configurations can allow for better noise control (control of a power supply rejection ratio, PSRR) and better regulation subject to changing loads. In a feedback loop of a typical regulator, a resistive divider can be used. In a possible embodiment, no resistive divider could be used, and the feedback loop would start directly from a voltage node 230 between two consecutive stages (except for the stage connected to ground). Such voltage node 230 may carry current noise from all other upstream stages. Therefore, filtering and buffering the signal of the feedback external loop 260 is often necessary. It is understood that any other suitable filter combination may be used.

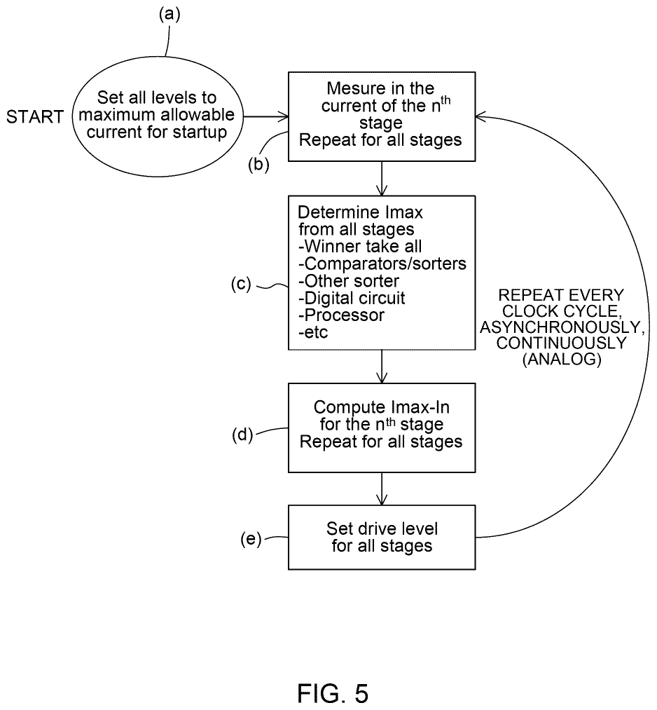

With reference now to FIG. 5, an exemplary method for controlling the spillways 300 of the plurality of stages 400 in regulator circuit 10 is shown according to an embodiment. The method can, for example, be implemented via the controller 500.

A first step (a) consists of setting all the stages 400 to a maximum allowable current at startup. For example, all the spillways 300 can be opened such that a maximal current passes therethrough, and all regulators and loads have sufficient current.

A second step (b) consists of measuring the pass current I_{A} circulating in each of the stages. The pass current Iₙ of a given stage n can be measured, and this can be repeated for the remaining stages. In some embodiments, the pass current of each stage can be measured in parallel.

In step (c), the maximum pass current I_{A} circulating in any of the n stages is determined to identify a master stage. The pass current A circulating in the master stage is identified as Iₘₐₓ. As can be appreciated, different strategies and corresponding circuitry can be used to identify the master stage and corresponding Iₘₐₓ, such as a “winner-take-all” circuit as described in J. Lazzaro, S. Ryckebusch, M. A. Mahowald, and C. A. Mead, “Winner-take-all networks of O(N) complexity,” in Advances in neural information processing systems 1, S. T. David Ed.: Morgan Kaufmann Publishers Inc., 1989, sec. 89944, pp. 703-711, the entirety of which is incorporated herein by reference. The “winner-take-all” circuit is fast and simple but works in current mode. Other strategies could include a series of comparators, where the amplitudes can be measured and compared in a computer microcontroller or processor.

Step (d) consists of determining the magnitude of current to allow to pass in the spillway 300 of each stage, by calculating Iₘₐₓ−Iₙ for each stage.

In step (e), each of the spillways 300 are controlled such that they allow the calculated current (Iₘₐₓ−Iₙ) to pass, by supplying the control voltage to the gate G₁ terminal 316 of each current spillway 300.

As can be appreciated, steps (a) to (e) can be repeated continuously, asynchronously, or periodically (for example each clock cycle if implemented in a digital controller) to accommodate changes in the dynamic loads 240.

As can be appreciated, the above-described regulator circuit topology can allow using a larger portion of energy from an input power source. In particular, the regulator circuit allows splitting a power supply voltage into smaller usable voltage domains that can be exploited more efficiently by low-voltage circuits. Where the input power source is a battery, this can allow increasing the useful lifespan of the battery, particularly in portable electronic equipment with low power consumption and/or having long hibernation profiles or idle periods.

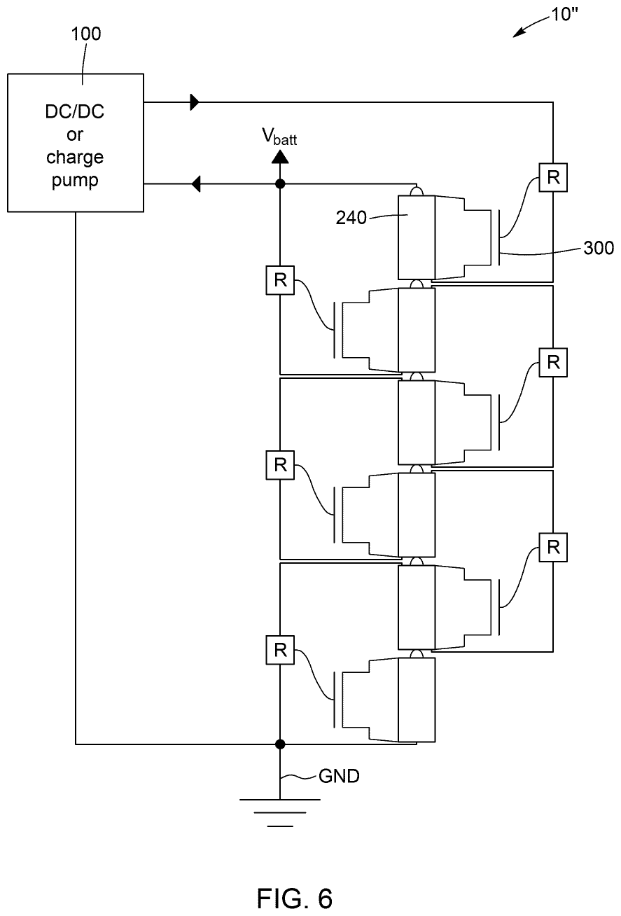

In some embodiments, the regulator circuit topology can be applied to efficiently balance cells in a battery. For example, with reference to FIG. 6, an electric vehicle battery controlled using an embodiment of a regulator circuit 10″ is illustrated. One of the main problems with automotive battery packs in electric vehicles is with balancing charge and bypassing failing or dead cells. Currently, large batteries for cars can have several thousands of cells. The series and parallel arrangement of such cells is monitored to a limited extent. This is partly because battery monitoring requires wiring, and wiring is tedious and ever-increasingly expensive due to the high cost of copper, the main metal used for wiring.

By applying a regulator circuit, such as the ones described herein, in a battery pack, efficient battery monitoring can be practically achieved. In addition, by adding a Manchester decoder and modulating a low current signal, dead cells in the pack can be completely bypassed using a circuit similar to the voltage regulator described above. Each control modules can communicate through the Manchester decoders and an impedance encoder could modulate a low current communication into the battery control circuit itself.

In the illustrated embodiment of FIG. 6, the loads 240 of the regulator circuit 10″ each correspond to a cell of a large battery pack. When the battery pack is not charging, cells 240 can be selectively bypassed via the spillways 300. MOSFETs used in the spillways 300 can also serve to adjust the voltage on neighboring cells during charging. If a cell fails or dies, the sensing voltage in the regulator “R” monitors circuit drops. The DC/DC circuitry of the charge pump 100 also contains communication systems that can interrogate individual regulators “R” to check the battery status via current mode communication systems. When one cell fails or dies, the next higher cell provides power to the controller to avoid single failures. Building a battery block in this way can avoid large amounts of control monitoring and charging circuitry, since large batteries (e.g. those found in electric vehicles) can contain several thousand cells, a large amount of expensive copper cable and weight can be avoided. The charge pump can provide a higher voltage than the low-current block voltage to allow the top cell to be regulated in the same way as its neighbors on the lower stages of the battery.

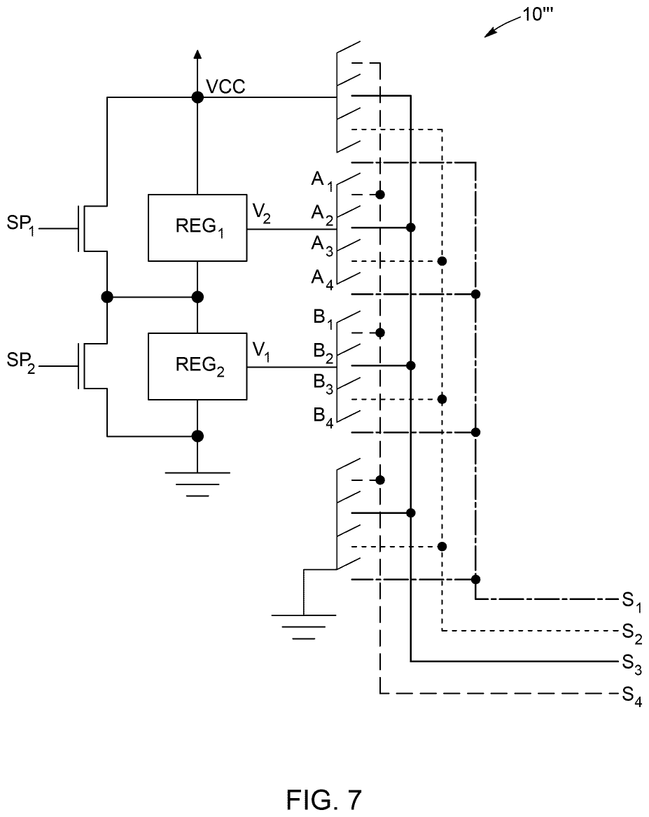

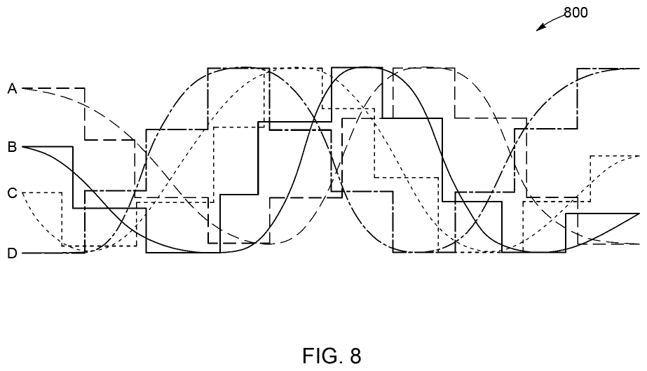

In yet further embodiments, the circuit topology can be used as part of an inverter for converting a direct current (DC) input into an alternating current (AC) output. An exemplary embodiment of a regulator circuit 10″ for converting DC to AC is shown in FIG. 7. In the illustrated embodiment, the circuit 10″ includes two stages comprising a first voltage regulator REG₁ and a second voltage regulator REG₂ configured to step down an input voltage VCC to two intermediate voltages V₁ and V₂ that evenly divide the voltage range between VCC and GND. The circuit 10′″ includes a commutation stage including a plurality of commutators (A₁, A₂, A₃, A₄, B₁, B₂, B₃, B₄ etc.) that allow selecting a voltage to provide as an output (S₁, S₂, S₃, S₄) from among VCC, V₁, V₂ and GND. The commutators can be operated in sequence to construct a sinusoid-like output, for example such as the output waveform 800 as shown in FIG. 8. In the present embodiment, a plurality of commutators are also provided for each of VCC, V₁, V₂ and GND, allowing to simultaneously generate a plurality of sinusoid-like outputs having different phases but supplying the same power.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention.

1. A regulator circuit for regulating an input voltage, comprising:
a plurality of voltage regulators connected in series to the input voltage; and
a current spillway operable to allow current to selectively bypass at least one of the plurality of voltage regulators.

2. The regulator circuit of claim 1, wherein the current spillway is configured to allow current to selectively bypass each of the plurality of voltage regulators.

3. The regulator circuit of claim 1, wherein each of the plurality of voltage regulators comprises an input terminal, an output terminal and a negative terminal; and each of the plurality of voltage regulators is configured to draw a load current to generate a specific output voltage across a load between its output terminal and negative terminal.

4. The regulator circuit of claim 3, wherein the plurality of voltage regulators is configured to generate specific output voltages in at least two different voltage domains.

5. The regulator circuit of claim 3, wherein at least one of the plurality of voltage regulators is configured to generate an output voltage below 1V.

6. The regulator circuit of claim 3, wherein the plurality of voltage regulators comprises a first voltage regulator, at least one subsequent voltage regulator, and a final voltage regulator; wherein the first voltage regulator has its input terminal connected to the input voltage, each of the at least one subsequent voltage regulator has its input terminal connected to the negative terminal of a previous voltage regulator; and the final voltage regulator has its negative terminal connected to a ground.

7. The regulator circuit of claim 3, wherein the current spillway of each of the plurality of voltage regulators is configured to allow an adjustable current to pass between the input terminal and the negative terminal of the voltage regulator.

8. The regulator circuit of claim 7, wherein the current spillway of each of the plurality of voltage regulators comprises a MOSFET having a first terminal connected to the input terminal of the voltage regulator, and a second terminal connected to the negative terminal of the voltage regulator, a control voltage applied to a gate terminal of the MOSFET allowing to adjust the current passing between the input terminal and the negative terminal of the voltage regulator.

9. The regulator circuit of claim 8, wherein the MOSFET is a low dropout MOSFET.

10. The regulator circuit of claim 3, comprising a plurality of stages, each stage comprising one of the plurality of voltage regulators and a corresponding current spillway; the regulator circuit further comprising a controller operatively connected to each of the plurality of stages, the controller being operable to selectively adjust the current passing through the current spillway in each of the stages, thereby adjusting a total current in each stage comprising the current passing through the current spillway and the load current drawn by the voltage regulator and the load.

11. The regulator circuit of claim 10, wherein the controller is configured to adjust the current passing through each of the current spillways such that the total current passing through each stage is equal.

12. The regulator circuit of claim 10, wherein the controller is configured to adjust the total current passing through each stage by:
detecting the current passing through each of the plurality of stages;
identifying a master stage corresponding to one of the plurality of stages drawing a highest total current, the other ones of the plurality of stages being identified as slave stages, and automatically adjusting the total current passing through the slave stages to match the current passing through the master stage.

13.-25. (canceled)

26. A method for regulating power supplied to a plurality of loads, the method comprising:
supplying power to the plurality of loads via a plurality of stages of voltage regulators connected in series to a power source;
determining one of the plurality of stages drawing a highest load current to power its load, the determined one of the plurality of stages being identified as a master stage and the remaining ones of the plurality of stages being identified as slaved stages; and
for each of the plurality of stages:
calculating a difference between the highest load current and the current drawn by the stage to power its load; and
causing a current to bypass the voltage regulator in the stage, the bypass current corresponding to the calculated difference;
whereby a total current drawn by each of the stages is equal, the total current of each stage corresponding to a sum of the current drawn by the stage to power its load and the current bypassing the voltage regulator in the stage.

27. The method of claim 26, wherein each of the plurality of stages comprises one of the voltage regulators and a corresponding current spillway.

28. The method of claim 27, wherein each current spillway is operable by a controller operatively connected to a gate of the corresponding current spillway, to selectively adjust the current passing through the current spillway in each of the stages, thereby adjusting a total current in each stage comprising the current passing through the current spillway and the load current drawn by the voltage regulator and the load.

29. The method of claim 28, wherein the controller is configured to adjust the current passing through each of the current spillways such that the total current passing through each stage is equal.

30. The method of claim 28, wherein the controller comprises a comparator circuit to compare the current drawn by each of the plurality of stages and identify the master stage, and a difference amplifier to subtract the current passing through each of the slave stages from the current passing through the master stage to compute a desired current through the spillway of each slave stage.

31. The method of claim 30, wherein each of the plurality of loads is a dynamic load, further wherein the controller is configured to continuously adjust the current passing through each of the plurality of stages to balance the voltage regulators as the current drawn by the dynamic load changes.

32. The method of claim 28, wherein the controller comprises one of an analog circuit and a digital circuit.

33. (canceled)

34. The method of claim 27, wherein each of the plurality of voltage regulators comprises an internal control loop to regulate voltage and an external control loop for controlling the current bypassing the voltage regulator via the current spillway, further wherein the internal and external control loops are modulated to control noise.
